(19) United States
(12) Patent Application Publication
(10) Pub. No.: US 2008/0099722 A1
(43) Pub. Date: May 1, 2008

(54) Method for Reducing Fouling in Furnaces

(75) Inventors: Joseph L. Stark, Richmond, TX (US); Thomas J. Falkler, Missouri City, TX (US)

Correspondence Address: MADAN, MOSSMAN & SRIRAM, P.C., 2603 AUGUSTA DRIVE, SUITE 700, HOUSTON, TX, 77057-5662, US

(73) Assignee: BAKER HUGHES INCORPORATED, Houston, TX (US)

(21) Appl. No.: 11/924,378

(22) Filed: Oct. 25, 2007

Related U.S. Application Data
(60) Provisional application No. 60/855,264, filed on Oct. 30, 2006.

(51) Int. Cl. C09K 3/00

(52) U.S. Cl. 252/182.29

(57) ABSTRACT

Fouling of hot furnace surfaces in selected refinery processes can be stopped or at least mitigated using an antifouling agent. The antifouling agent is a mixture of magnesium and aluminum overbases. The antifouling agent is admixed with hydrocarbon feeds prior to passing the hydrocarbon feeds through a furnace. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or meaning of the claims. 37 CFR 1.72(b)

### CROSS REFERENCE TO RELATED APPLICATIONS

This Application claims priority from the U.S. Provisional Patent Application of the same title and inventorship and having the Ser. No. 60/855,264; which was filed on Oct. 30, 2006.

### BACKGROUND OF THE INVENTION

1. Field of the Invention

The present invention relates to additives useful for reducing fouling in furnaces. The present invention particularly relates to metal additives useful for reducing fouling in furnaces.

2. Background of the Art

Petrochemical plants, which include both Chemical Production Installations as well as Oil Refineries, are known to employ two basic types of furnaces. The first of these is a steam cracker furnace. Steam crackers are used in applications including the production of ethylene. The second of these is a “steam reformer” furnace, which can be used to make hydrogen. Both types of furnaces include a number of tubes, generally arranged vertically, that form a continuous flow path, or coil, through the furnace. The flow path or coil includes an inlet and an outlet. In both types of furnaces, a mixture of a hydrocarbon feedstock and steam are fed into the inlet and passed through the tubes. The tubes are exposed to extreme heat generated by burners within the furnace. As the feedstock/steam mixture is passed through the tubes at high temperatures the mixture is gradually broken down such that the resulting product exiting the outlet is ethylene in the case of a steam cracker furnace and hydrogen in the case of a steam reformer furnace.

Other types of furnaces may also be used, but the one element that they have in common is the passing of a feed material through a flow path that is subject to heat from a burner or other heat source. The deposit of any insulating material on the heat exchange surfaces of the flow path can be undesirable in that it can result in increased energy costs as temperatures are increased to overcome the effect of the insulating deposits and increase operational costs when the furnaces are shut down for periodic cleaning of the heat exchanging surfaces. It would therefore be desirable in the art of manufacturing products using processes which include subjecting hydrocarbon streams to heat to avoid or mitigate the formation of fouling deposits on heat exchanging surfaces.

### SUMMARY OF THE INVENTION

In one aspect the invention is a process for reducing furnace fouling comprising treating a furnace feed stream with an antifouling agent wherein the antifouling agent comprises a magnesium overbase and an aluminum overbase.

### BRIEF DESCRIPTION OF THE DRAWINGS

For a detailed understanding of the present invention, reference should be made to the following detailed description of the preferred embodiments, taken in conjunction with the accompanying drawing(s) wherein:

FIG. 1 is a photomicrograph showing a comparative amount of fouling from an untreated process feed;

FIG. 2 is a photomicrograph showing a comparative amount of fouling from a process feed treated with a magnesium overbase;

FIG. 3 is a photomicrograph showing a comparative amount of fouling from a process feed treated with an aluminum overbase; and

FIG. 4 is a photomicrograph showing a comparative amount of fouling from a process feed treated with a mixed aluminum and magnesium overbase antifouling agent of the invention.

### DESCRIPTION OF THE PREFERRED EMBODIMENTS

In one embodiment, the present invention is an antifouling agent comprising a magnesium overbase and an aluminum overbase. The terms “overbase” and “overbases” refers to compounds with a great capacity of neutralizing acids. The term(s) aluminum and magnesium overbases mean that the subject overbases contain atoms of these metals. The treating agents used in the present invention may be prepared in any manner known to those of ordinary skill in the art for preparing such overbases to be useful. In one embodiment, the magnesium overbase is a magnesium oxide/magnesium carboxylated overbase complex. The overbase is desirably in the form of finely divided, preferably submicron (no dimension greater than 1 micron), particles which can form a stable dispersion in oil.

One method of preparing such a magnesium oxide/magnesium carboxylated-overbase complex is to form a mixture of a base of the desired metal; e.g., Mg(OH)₂, a complexing agent; e.g., a fatty acid such as a tall oil fatty acid, which is present in a quantity much less than that required to stoichiometrically react with the hydroxide, and a non-volatile diluent. The mixture is heated to a temperature of about 250 to 350° C. to produce the overbase complex of the metal oxide and metal salt of the fatty acid.

Such process are known in the prior art. For example, the process of U.S. Pat. No. 4,163,728, which is fully incorporated herein by reference, may be used. Therein, it is disclosed that the a magnesium carboxylate can be prepared using a process employing minor percentages of stoichiometric amounts of carboxylic acid such as less than about 50% of the calculated stoichiometric amount. In this process, any suitable carboxylic acid at low stoichiometry can be employed. These include mono- and polycarboxylic acids including aliphatic, aromatic, and cycloaliphatic, carboxylic acids. Representative examples include: formic acid, acetic acid, propionic acid, butyric acid, acrylic acid, maleic acid, and the like.

Any suitable magnesium carboxylate capable of being subdivided upon decomposition into submicron particles of magnesia can be employed in the magnesium carboxylate-magnesium hydroxide mixture. Magnesium acetate is the preferred starting magnesium carboxylate compound in such mixture whether starting as the anhydrous solid, hydrated solid or aqueous slurry, or as magnesium carboxylate formed in situ. The magnesium overbases acceptable for the method of this invention may also include overbase compounds where a carbonation procedure has been done. Typically, the carbonation involves the addition of CO2, as is well known in the art.

Any suitable non-volatile process fluid capable of being heated to the decomposition temperature of the magnesium carboxylate-magnesium hydroxide mixture can be employed. The process fluid should be relatively stable and relatively non-volatile at the decomposition temperature. However, any volatility encountered is readily controlled by refluxing and condensing apparatus. Examples of such non-volatile process fluids are as follows: hydrocarbons (such as mineral oil, paraffin oil, or aromatic oil), diphenyl oxide fluids, silicone oils, polyglycol ethers or vegetable oils, etc., solely the dispersant, or any combinations thereof.

In some embodiments, the non-volatile process fluid may contain a dispersant(s) capable of retaining the magnesium compound formed by decomposition in stable suspension. Any suitable dispersant which is relatively stable under the decomposition conditions of this invention can be employed. Exemplary dispersants include saturated and unsaturated fatty acids (such as stearic acid and oleic acid) and derivatives thereof (such as sorbitan mono-oleate), sulfonic acids (such as mahogany or petroleum derived sulfonic acids and synthetic sulfonic acids), naphthenic acids, oxyalkylated fatty amines, alkylphenols, sulfurized alkylphenols, oxyalkylated alkylphenols, and the like.

Similarly, the aluminum overbases useful with present invention may be made using any method known to those of ordinary skill in the art of preparing such compounds to be useful. For example, in one process to make an aluminum overbase, dodecylbenzene sulfonic acid is admixed with kerosene and isobutanol to form a first solution. The first solution is then acidified with a nitric acid and then admixed with alumina. This solution is then subject to distillation to remove water and solvent resulting in an aluminum sulfonic acid overbase.

While metal overbases have been known to be useful in applications including treating the feed for FCC processes to improve yields, it has been surprisingly discovered that there is a synergistic improvement to admixing a magnesium overbase and an aluminum overbase to produce an antifouling agent that is superior to use of either component in absence of the other. The antifouling agents of the invention include a magnesium overbase and an aluminium overbase, with the two components being present in the agent at a weight concentration of each metal [Mg:Al] of from about 1:99 to about 99:1. In one embodiment, the ratio of Mg:Al is from 90:10 to 10:90. In still another embodiment, the ratio of Mg:Al is from about 80:20 to about 20:80. In yet another embodiment the ratio of Mg:Al is from about 70:30 to about 30:70, or about 60:40 to about 40:60.

The antifouling agents of the invention may be used in processes wherein hydrocarbons are contacted with extreme heat to reduce or mitigate fouling. For example, the agents of the invention are particularly useful in furnace feed streams in coking and visbreaking applications. In one embodiment of a visbreaking process, the process takes place in a facility having: (1) a train of exchangers into which the process feed enters for initial pre-heating, (2) followed by a furnace in which thermal cracking takes place, (3) then a fractionating column, from the base of which flows the residue (tar), which passes through (4) the exchangers, transferring part of its heat to the charge. In some applications there is also a “soaker” between the furnace and the fractionating column which increases the time at which the process feed is held at high temperature. The operating conditions of a plant of this kind include a furnace temperature of from about 420 to about 500° C. (in the presence or in the absence of “soaker”, respectively) and a pressure of between 3 and 20 bar. Typically, the process feed is a primary distillation residue or of a vacuum residue. A visbreaking process is typically managed with the aim of obtaining maximum transformation of hydrocarbons into medium and light distillates.

Coking, a term associated with the refining of the heavy bottoms of petroleum, is a process in which the heavy residual bottoms of crude oil are thermally converted to lower-boiling petroleum products and by-product petroleum coke. Delayed coking involves the rapid heating of reduced crude in a furnace and then confinement in a coke drum under proper conditions of temperature and pressure until the unvaporized portion of the furnace effluent is converted to vapor and coke. In either process the feed is typically a very heavy hydrocarbon, often a residue from another process within a refinery.

The anti-fouling agent of the invention may be used with other refinery process as well. For example, the method of the invention may be used with vacuum distillation tower furnaces. The process of the invention may be used in any circumstance where a hydrocarbon feed is being fed through a furnace at temperatures that would induce fouling of the heat exchanging surfaces of the furnace. For the purposes of the invention, these temperatures are those from about 260° C. to about 870° C. Further, also for the purposes of the invention, the term “furnace feed stream” means not just feeds going into a furnace, but rather any circumstances wherein a hydrocarbon is brought into contact with a surface, especially the surface of a heat exchanger, at a temperature of from 260° C. to about 870° C.

The antifouling agents of the invention may be used in any amount that is effective to stop or mitigate fouling. The amount that is necessary will be, to some extent, dependent upon the properties of the hydrocarbon feed in which it will be used. In most cases, the hydrocarbon feed will be a very heavy hydrocarbon feed with a significant tendency to produce fouling. The amount of antifouling agent useful with method of the invention will range, as a weight percent of the hydrocarbon feed (furnace feed stream), of from about 1 ppm to about 10,000 ppm. In one embodiment, the range is from about 50 ppm to about 600 ppm. In another embodiment, the range is from about 250 ppm to about 500 ppm.

The antifouling agents of the invention may be introduced into their target feed material in any way known to be useful to those of ordinary skill in the art of refining crude oil subject to the caveat that the antifouling agents are introduced prior to the feed contacting the surfaces which are to be protected from fouling. For example, in one application of the invention, the antifouling agent is injected into the feed material as they pass through a turbulent section of a coking process. In another application, the antifouling agent is admixed with the feed in holding vessel that is agitated. In still another application, the antifouling agent is admixed with the feed immediately upstream of a furnace by injecting it into a turbulent flow, the turbulent flow being created by static mixers put into place for the purpose of admixing the antifouling agent with a feed material.

While not wishing to be bound by any theory, it is believed that the antifouling additives of the present invention inhibit asphaltenes, and other hydrocarbon components that would otherwise form a fouling layer upon a heat exchange surface, from coalescing or agglomerating, thereby lessening the amount of such species fouling the hot surfaces of the furnace.

### EXAMPLES

The following examples are provided to illustrate the present invention. The examples are not intended to limit the scope of the present invention and they should not be so interpreted. Amounts are in weight parts or weight percentages unless otherwise indicated.

### Comparative Example A (Control)

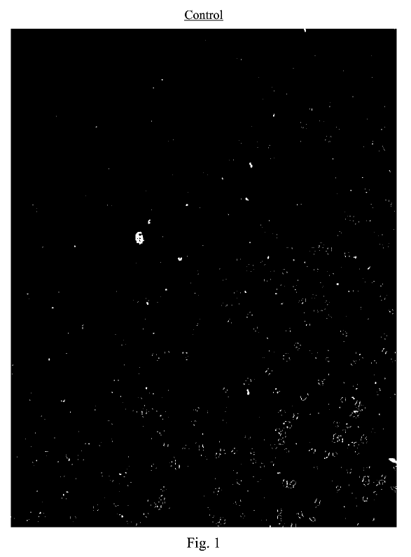

A heavy hydrocarbon feed which is a residue of a vacuum tower distillation unit in refinery is heated to 910° F. (488° C.) and held at that temperature for about 30 minutes. The heavy hydrocarbon feed is allowed to cool to ambient temperature. 1 ml of the heavy hydrocarbon feed is admixed with 0.5 ml of cyclohexane. One drop of the diluted heavy hydrocarbon feed is then placed on a microscope slide and covered with a coverslip. The material on the slide is then observed at 200 magnification and a photomicrograph is prepared and attached hereto as FIG. 1.

### Comparative Example B (Magnesium Overbase)

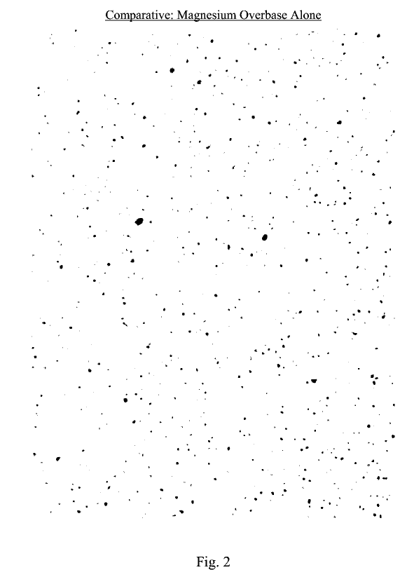

Comparative Example A is reproduced substantially identically except that the heavy hydrocarbon feed is first admixed with a magnesium carboxylate overbase (prepared using tall oil fatty acids) at a concentration of about 500 ppm prior to being heated. The photomicrograph is attached hereto as FIG. 2.

### Comparative Example C (Aluminum Overbase)

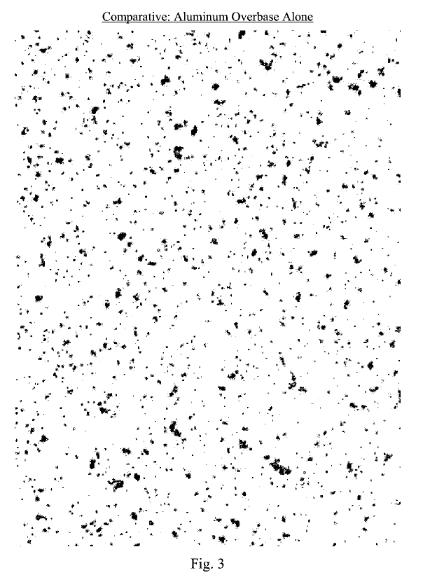

Comparative Example A is reproduced substantially identically except that the heavy hydrocarbon feed is first admixed with an aluminum overbase at a concentration of about 500 ppm prior to being heated. The aluminum overbase is prepared using dodecylbenzene sulfonic acid, isobutanol, nitric acid and alumina. The photomicrograph is attached hereto as FIG. 3.

### Example 1

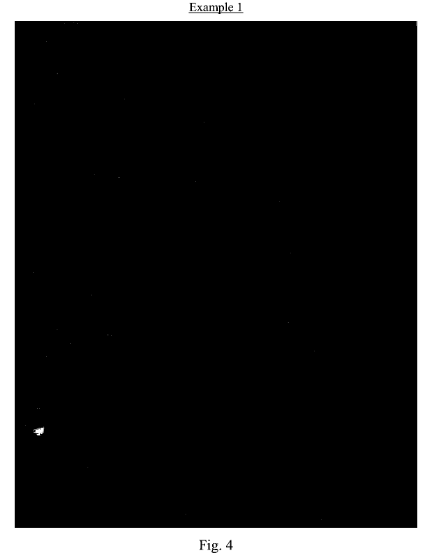

Comparative Example A is reproduced substantially identically except that the heavy hydrocarbon feed is admixed with an antifouling agent of the invention at a concentration of about 500 ppm prior to being heated. The antifouling agent is an admixture of 1 part of the magnesium overbase used in Comparative Example B and 1 part of the aluminum overbase used in Comparative Example C. The photomicrograph is attached hereto as FIG. 4.

### Discussion of the Examples

The examples clearly show that the control has the most agglomerations and of the largest particles. The other two comparative examples have a comparatively reduced amount of such agglomerations, but neither is as agglomerate free as the example of the invention which has significantly fewer and much smaller visible particles.

What is claimed is:

1. A process for reducing furnace fouling comprising treating a furnace feed stream with an antifouling agent wherein the antifouling agent comprises a magnesium overbase and an aluminum overbase.

2. The process of claim 1 wherein the magnesium overbase is a magnesium oxide/magnesium carboxylated overbase complex.

3. The process of claim 1 wherein the aluminium overbase is an aluminum sulfonic acid overbase.

4. The process of claim 1 wherein the magnesium overbase and aluminum overbase are in a form of finely divided particles.

5. The process of claim 4 wherein the finely divided particles are less than one micron in any dimension.

6. The process of claim 1 further comprising including a dispersant within the furnace feed stream.

7. The process of claim 6 wherein the dispersant is selected from the group consisting of: saturated fatty acids, unsaturated fatty acids, fatty acid derivatives, sulfonic acids, naphthenic acids, oxyalkylated fatty amines, alkylphenols, sulfurized alkylphenols, oxyalkylated alkylphenols, and mixtures thereof.

8. The process of claim 7 wherein the unsaturated fatty acids are selected from the group consisting of stearic acid, oleic acid and mixtures thereof.

9. The process of claim 7 wherein the fatty acid derivative is sorbitan mono-oleate.

10. The process of claim 1 wherein the ratio of magnesium from the magnesium overbase to the aluminium from the aluminium overbase is from 1:99 to 99:1.

11. The process of claim 10 wherein the ratio of magnesium from the magnesium overbase to the aluminium from the aluminium overbase is from 40:60 to 60:40.

12. The process of claim 1 wherein the furnace feed stream is within a visbreaking operation.

13. The process of claim 1 wherein the furnace feed stream is within a coking operation.

14. The process of claim 1 wherein the temperature of the process is from about 260° C. to about 870° C.

15. The process of claim 1 wherein the antifouling agent is present in the furnace feed stream at a weight concentration of from about 1 ppm to about 10,000 ppm.

16. The process of claim 15 wherein the antifouling agent is present in a furnace feed stream at a weight concentration of from about 50 ppm to about 600 ppm.

17. The process of claim 16 wherein the antifouling agent is present in a furnace feed stream at a weight concentration of from about 250 ppm to about 500 ppm.

18. The process of claim 1 further comprising introducing the antifouling agent into the furnace feed stream prior to the feed stream entering a furnace.

19. The process of claim 1 further comprising introducing the antifouling agent into the furnace feed stream concurrently with the feed stream entering a furnace.

20. An antifouling agent comprising a magnesium overbase and an aluminum overbase.

21. The antifouling agent of claim 20 wherein the magnesium overbase is a magnesium oxide/magnesium carboxylated overbase complex.

22. The antifouling agent of claim 20 wherein the aluminium overbase is an aluminum sulfonic acid overbase.

23. The antifouling agent of claim 20 wherein the ratio of magnesium from the magnesium overbase to the aluminium from the aluminium overbase is from 1:99 to 99:1.

24. A composition comprising an antifouling agent of claim 20 and a furnace feed stream.

25. The composition of claim 24 wherein the antifouling agent is present in the furnace feed stream at a weight concentration of from about 1 ppm to about 10,000 ppm.
